(19) United States
(12) Patent Application Publication
(10) Pub. No.: US 2010/0324980 A1
(43) Pub. Date: Dec. 23, 2010

(54) METHOD AND SYSTEM FOR REVENUE SHARING

(76) Inventor: Shannon Schantz, Columbus, MI (US)

Correspondence Address: YOUNG BASILE, 3001 WEST BIG BEAVER ROAD, SUITE 624, TROY, MI, 48084, US

(21) Appl. No.: 12/818,533

(22) Filed: Jun. 18, 2010

Related U.S. Application Data
(60) Provisional application No. 61/218,227, filed on Jun. 18, 2009.
(60) Provisional application No. 61/309,622, filed on Mar. 2, 2010.

(51) Int. Cl. G06Q 30/00; G06Q 10/00; G06Q 20/00

(52) U.S. Cl. 705/14.14; 705/30

(57) ABSTRACT

Disclosed herein is a method of sharing revenue contributions between a plurality of users. The method includes providing at least one prize pool, contributing revenue to the at least one prize pool based on at least one revenue source, providing drawing entries to the plurality of users, selecting at least one of a plurality of drawing entries and awarding a prize to at least one of the plurality of users from the at least one prize pool.

### CROSS-REFERENCE TO RELATED APPLICATIONS

This application claims priority to U.S. Provisional Patent Application Ser. No. 61/218,227, filed Jun. 18, 2009 and U.S. Provisional Patent Application Ser. No. 61/309,622, filed Mar. 2, 2010, both of which are hereby incorporated by reference in their entirety.

### BACKGROUND

Currently, there are many websites that permit buyers to purchase items from sellers through the Internet. These websites, such as eBay, permit a seller to place an item/service for sale through, for example, an auction sale or by a direct purchase format. Once sellers list the item for sale on the website, they commonly can be charged a listing fee. Further, in many cases, once the item is sold to a buyer, they may be charged a selling fee. Sellers have an incentive to pay these fees because the website may have a large user base or may be well known, giving the seller a higher chance of selling the item.

Buyers also have an incentive to use these websites because there may be an abundant amount of sellers selling a wide variety of items. However, once a buyer decides to purchase an item, the buyer may be charged a buyer's premium (e.g., a percentage of the purchase price of the item).

The use of these websites can cause the seller to pay to sell an item and can cause the buyer to pay additional money to buy that item. Accordingly, each party may either receive less value from the transaction or may choose to not enter into the transaction at all. Accordingly, buyers and sellers can be left with less motivation to buy or sell a good/service because of the additional fees incurred on both sides of the transaction.

Commonly, the website is the main entity that benefits from the additional fees that are charged to the buyer/seller. Additionally, the website can also benefit from revenue generating mechanisms, such as advertising. Furthermore, these websites may force the buyers to pay for an item through a third party web-based system that permits the secure transfer of funds between accounts (e.g. PayPal). The seller of the item may be charged additional fees, such as a transaction fee or a percentage of the sale price, to be able to accept payment for the item using the third party system.

### SUMMARY

In the above description, buyers and sellers neither benefit from any of the transaction fees that are charged to the buyer/seller nor do they benefit from any revenue generating mechanisms the website may employ. In contrast, embodiments of a method for sharing revenue contributions between a plurality of users are disclosed herein. One such method includes providing at least one prize pool, contributing revenue to the at least one prize pool based on at least one revenue source, and providing drawing entries to the plurality of users. The method further includes selecting at least one of a plurality of drawing entries and awarding a prize to at least one of the plurality of users from the at least one prize pool.

Embodiments of a system for sharing revenue contributions between a plurality of users are also disclosed herein. One such system includes a plurality of user computers configured to permit the plurality of users to initiate a transaction over a communications network. The system also includes a platform controlled by a platform operator and configured to communicate with the plurality of user computers over the communications network. The platform also processes the transaction. Further, the system includes a server in communication with the platform. The server is configured to provide at least one prize pool, contribute revenue to the at least one prize pool based on at least one revenue source, provide drawing entries to the plurality of users and select at least one of a plurality of drawing entries.

Embodiments of a method and system for sharing revenue between a plurality of users and a platform operator are also disclosed herein. One such method includes calculating a gross sales and purchases (GSP) amount for each of the plurality of users, calculating a total gross sales and purchases amount (TGSP) based on the sum of all the GSP amounts, calculating a net profit share for the user based on the user's GSP share of the TGSP and calculating a total net profit (TNP) based on at least one revenue source. The method further includes calculating the users' share of the total net profit (TNP) and distributing revenue to the user based on the user's net profit share and the total of all of the users' shares of the TNP.

Details of these and other embodiments of the invention are described in additional detail hereinafter.

### BRIEF DESCRIPTION OF THE DRAWINGS

The description herein makes reference to the accompanying drawings wherein like reference numerals refer to like parts throughout the several views, and wherein:

FIG. 1 is a block diagram of an exemplary system for sharing revenue according to one embodiment of the invention;

FIG. 2 is a flow diagram of revenue flow used in the system of FIG. 1;

FIG. 3 is a flow diagram of a process of sharing revenue in the system of FIG. 1;

FIG. 4 is a flow diagram of creating the system of FIG. 1;

FIG. 5 is a block diagram of an exemplary system for sharing revenue according to another embodiment of the invention; and

FIG. 6 is an exemplary user interface screen used in the system of FIG. 1;

FIG. 7 is a flow diagram for the purchase of goods and services used in the system of FIG. 1;

FIG. 8 is a flow diagram for the sale of goods and services as used in the system of FIG. 1;

FIG. 9 is a flow diagram for the purchase of goods and services through a banner ad as used in the system of FIG. 1;

FIG. 10A is a schematic diagram of a buyer's printout used in the system of FIG. 1;

FIG. 10B is a schematic diagram of a seller's printout used in the system of FIG. 1;

FIG. 11 is another exemplary user interface screen used in the system of FIG. 1;

FIG. 12 is a flow diagram for flagging an item as used in the system of FIG. 1;

FIG. 13 is a schematic diagram of a prize pool as used in another exemplary system for sharing revenue;

FIG. 14 is a flow diagram for marking a listing as a first look listing as used in the system of FIG. 1; and

FIG. 15 is a flow diagram for displaying first look listings as used in the system of FIG. 1.

### DETAILED DESCRIPTION

Embodiments of the invention provide a method for implementing a business model that is beneficial to all participants involved in a transaction. The business model permits buyers, sellers and an owner of a platform enabling the selling and buying of goods or services to each have a share of the profits received during the buying and selling process. The owner of the platform may be a website owner, but does not necessarily have to set up the platform on the Internet. For instance, the platform owner can be the owner of a publication (e.g., a newspaper) that sells advertisement space.

The business model permits buyers and sellers (i.e., users) to become “profit partners” or “revenue partners” with the owner of the platform. The extent to which the buyers and sellers share in the revenues of the business can be based on a user's performance factor and the total net profit. A user's performance factor is based on, for example, the seller's total gross sales and purchase amount as a buyer from other sellers that are users of the platform. The total net profit can be based on the buying and selling commission, advertisement revenues, affiliate revenues, retail sales of goods/services, retail purchases of goods/services and listing fees.

Alternatively, the extent to which the buyers and sellers share in the revenues of the business can be based on the user's performance factors, as discussed above and the total revenue share (rather than the total net profit). Unless specifically distinguished herein, it is to be understood that reference to the total net profit or the user's share of the total net profit can alternatively be replaced with the total revenue or the user's share of the total revenue, respectively.

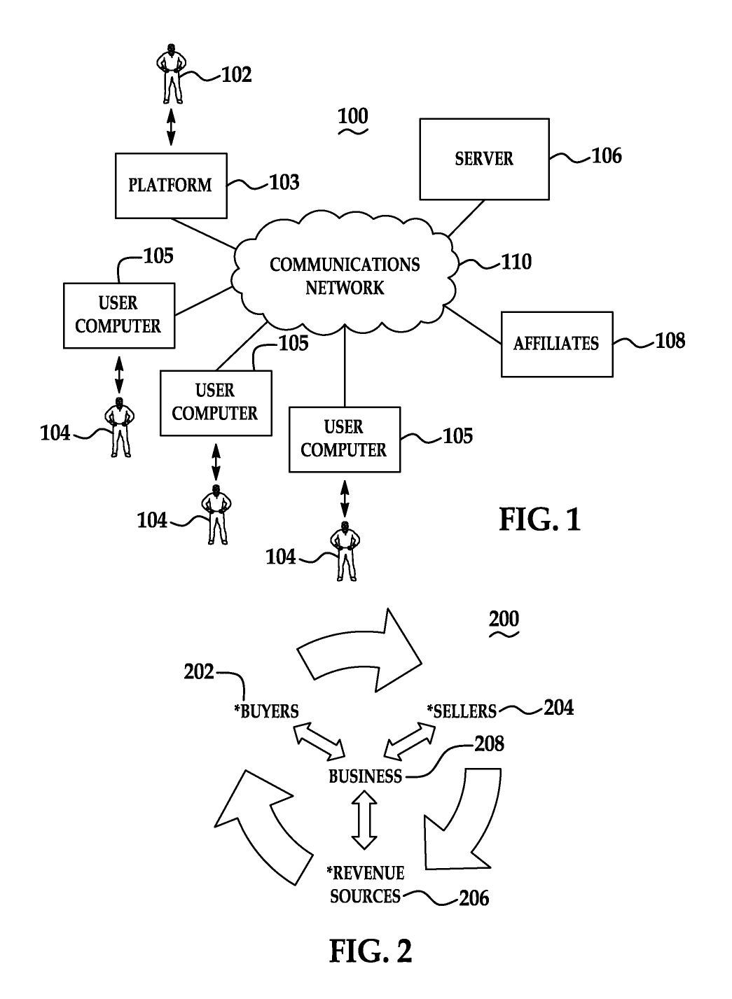

FIG. 1 illustrates a block diagram of an exemplary system 100 for sharing revenue according to one embodiment of the invention. System 100 as shown includes a platform owner or operator 102, a platform 103, users 104, user computers 105, a server 106 and affiliates 108. Platform 103, user computer 105, server 106 and affiliates 108 are coupled to a communications network 110. System 100 permits platform operator 102 and users 104 to share profit with one another.

Platform owner 102 can be, for example, an individual, a business entity, a government, an organization, a community, a network, an agency, a non-profit organization or any other person or entity. Platform owner 102 controls, for example, the creation and operation of platform 103. Platform 103 can be a web-based implementation or a non-web-based implementation. Platform 103 can be an auction service, a listing service, an advertising service, a publication service, a dealership of or any other type of platform, service or program. Platform 103 permits, for example, the selling, buying, exchange, rental, leasing or transferring of a good and/or service from one user 104 to another user 104. The good and/or service can be new, used or refurbished. The good and/or service can be tangible or intangible.

Examples of tangible goods to be sold may include but are not limited to cars, trucks, vehicles, parts, tractors, jewelry, real estate property, construction equipment, equipment, boats, motorcycles, electronics, computers, tools, commercial cars and trucks, semi trucks, tow trucks, trailers, bicycles, sporting goods, collectables, antiques, toys, building materials, farm equipment, supplies, oils, food products, dirt, aggregates, trees and shrubbery, landscape materials, stone and boulders, beauty products, furniture, medical supplies and equipment, recreational vehicles, ATV's, camper trailers, motor homes, jet skis, snowmobiles, any type of motorized vehicles, vitamins and supplements, clothing, shoes, event tickets, pictures, books, magazines, videos, movies, music and/or music compact disks, any and/or all downloadable or uploadable tangible goods, software, computer software, or computers. Other tangible goods are also available.

Examples of intangible goods to be sold may include but are not limited to insurance, verbal and/or nonverbal contracts and/or agreements, repair services, travel services, mobile and/or wireless services, radio services, television and/or cable services, matchmaking services, interne dating services, videos, pictures, licenses, any and/or all downloadable or uploadable good and/or services such as music, movies, video, pictures, images, documents, letters, voice recordings, audio books, audio, subscriptions, rental and/or lease contracts. Other intangible goods are also available.

Users 104 are buyers, sellers or both buyers and sellers of the good or service. Alternatively, users 104 are advertisers, rentors, rentees, lessees, or lessors of a good or service. User 104 can be, for example, an individual, a business entity, a government, an organization, a community, a network, an agency, a non-profit organization or any other person or entity.

Server 106 calculates the profit share for, for example, platform operator 102, users 104 and affiliates 108. In alternative embodiments, server 106 calculates the profit share only for platform operator 102 and users 104. Although server 106 is shown as a separate component, server can be integrated into platform 103 or any other server. Alternatively, platform operator 102 can calculate the profit share for the platform operator 102 and users 104 by hand. As a result, system 100 does not include a server 106.

Communications network 110 may be one or more networks such as the Internet. Communications network 110 may also be any other suitable wired or wireless communications path.

FIG. 2 illustrates a flow diagram 200 of revenue flow in system 100. Buyers 202, sellers 204 and revenue sources 206 all input revenue into business 208. Business 208 can be, for example, platform 103 of FIG. 1. Buyers 202 input, for example, transaction fees, buying commission or retail goods and/or services purchases into business 208. Other revenues from buyers 202 are also available. Sellers 204 input, for example, listing fees, transaction fees and selling fees, retail goods and/or services sales into business 208. Other revenues from sellers 204 are also available. Revenue sources 206 include any other direct or indirect sources of revenue other than revenues from buyers 202 and sellers 204 such as advertising revenues, retail revenue, affiliate commission revenue, etc.

System 100 permits buyers 202, sellers 204 and revenue sources 206 to receive revenue through business 208. For example, buyers 202, sellers 204, revenue sources 206 and business 208 receive all or a portion of buyer transaction fees, seller transaction fees, seller listing fees, seller selling fees, advertising revenues, retail revenues or affiliate commission revenues. Accordingly, system 100 permits 202, sellers 204 revenue sources 206 and business 208 to share in the revenue or profit generated by business 208. In other embodiments, business 208 does not receive any revenue sources.

Returning to FIG. 1, platform operator 102 can use platform 103 to, for example, create a website where users 104 (i.e., sellers) can list goods or services for sale and users 104 (i.e., buyers) can buy these goods or services. Using system 100, platform operator 102 and users 104 share the profits that are generated within or by the use of platform 103. According to one example, the amount of profit paid to users 104 can be scaled based on the net profit generated by platform 103. Accordingly, if a larger profit is generated by platform 103, users 104 can receive a larger share of profit and if a smaller profit is generated by platform 103, users 104 can receive a smaller share of profit. User 104 can also receive a larger share of the generated profit based on that particular user's amount of sales and purchases. In alternative embodiments, the share of profit can be based on other factors, for example, the number of sales or purchases made by user 104 rather than the amount of revenue generated thereby.

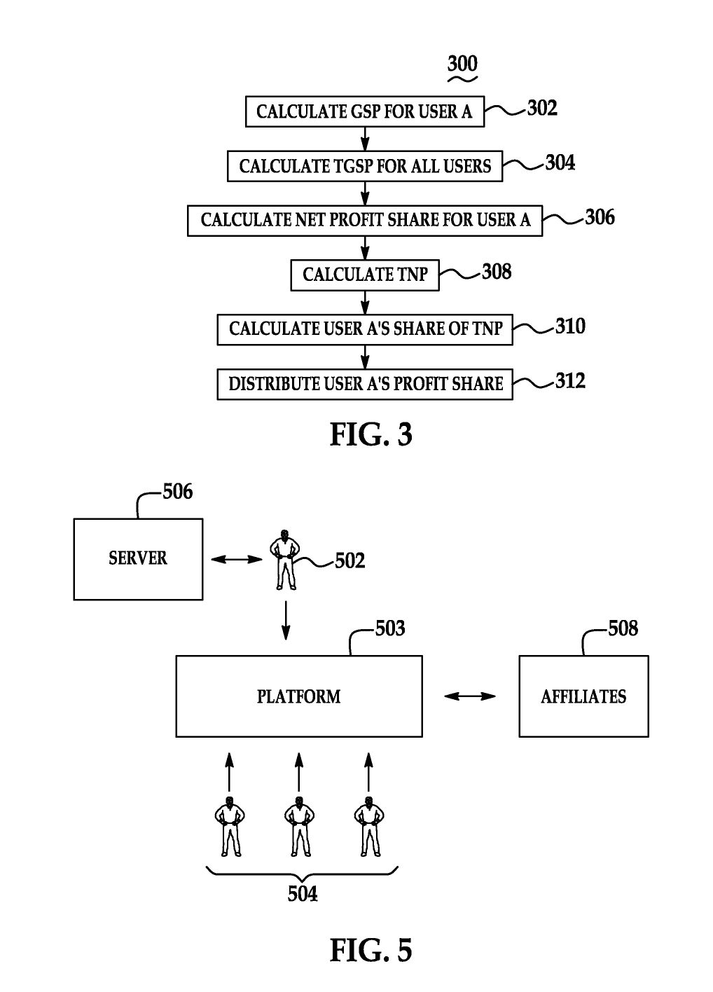

FIG. 3 illustrates a flow diagram of the process of sharing revenue or profit between the platform operator 102 and users 104 of the system 100 according to one embodiment. The process can be implemented in part by, for example, control software on server 106. In that case, server 106 includes a central processing unit, memory and input and output connectors for implementing the control software, and the control software is stored on board the server 106.

At step 302, a gross sales and purchases (GSP) amount is calculated for a User A and any other users 104. Control then moves to step 304, where a total gross sales and purchases amount (TGSP) is calculated based on the GSP for all users 104. Control then moves to step 306, where a net profit share for user A is calculated based on User A's GSP share of the TGSP. Control then moves to step 308 to calculate the total net profit (TNP). The TNP can be based on, for example, buying and selling commission, advertisement revenues, affiliate revenues, retail sales of goods/services, retail purchases of goods/services and listing fees.

Affiliate revenues are generated, for example, when a buyer purchases a good and/or service from an external site as a result of clicking on an advertisement within a website associate with platform 103. Advertisements can generate revenue by pay-per-click revenue, payment by an advertiser to place an ad, auctioning of ad space, payments by an advertiser based on the gross sales generated by the ad, etc.

Control then moves to step 310 where User A's profit share is calculated. After User A's profit share has been calculated, User A's profit share is distributed to User A in step 312. The profit share is distributed electronically or by conventional means such as a paper check. Other distribution methods can also be used. The profit share can also be calculated using the above process for platform operator 102 or affiliates 108.

The following is an illustrative example of how platform operator 102 and users 104 can split the profits equally. In this example, affiliates 108 are not included in the profit sharing business model. Accordingly, 50% of the net profit is distributed to platform operator 102, and 50% of the net profit is distributed to users 104 (i.e. buyers and sellers).

The amount of the 50% share that each buyer and seller can receive can be calculated by the amount of gross sales and/or purchases the buyer or seller participated in, as discussed previously.

For example, if registered User A purchased $2,000 worth of items and sold $18,000 worth of items, his Gross sales and purchases would be $20,000. The percent of the Net Profit share that User A can receive is equal to User A's percent of the Total Gross Sales and Purchases of all users. Preferably, all users undergo a registration process and so are also called registered users herein. Accordingly, if user A accounted for 10% of the Total Gross Sales and purchases of all users, user A would get 10% of the “registered users” Net Profit Share (i.e., 50%) of the Total Net Profit of platform 103. The calculations for this example are shown as follows:

Registered User A: Gross sales and Purchases (GSP)=$20,000;

Total Gross Sales and purchases of all users (TGSP)=$200,000; and

Users A's % of Total gross sales and purchases (TGSP)=10% ($20,000/$200,000).

Accordingly, since User A has 10% of the Total gross sales and purchases of all users, User A is entitled to 10% of the Total Net Profit (TNP).

In this example, if Total Net Profit (TNP) for the site was $100,000, the total users' share of 50% would be $50,000. User A's share would be would be $5,000 (10%×$50,000). Although the example calculates and determines User A's share in terms of monetary compensation, User A could also be compensated by other compensation such as stocks, incentives or any other reward.

In the above example, sales in the gross sales and purchases are credited twice, once for the buyer and once for the seller. However, in other embodiments, sales can be credited differently. For example, sales may be credited only once on the buyer side or on the seller side. Further, the calculations are based on an equal split of profit between the platform operator 102 and users 104. In other embodiments, the platform operator 102 and users 104 can have a different share of the total net profit, such as 60% and 40% respectively. In other embodiments, sellers may receive a higher share of the profit than buyers or vice versa. In certain embodiments, gross sales and purchases may include external purchases, such as those through an affiliate vendor or advertiser on the site.

Alternatively, if the calculations above were based on total net revenue (TNR), it may not be necessary to calculate the total net profit (TNP). Accordingly, the calculations can be based on the division of the revenue of the users rather than a profit. In some embodiments, the TNR can include all or at least a portion of the TNP. Platform operator 102 can, for example, pay for expenses and operating costs out of his share of the TNR.

In other embodiments, the number of users 104 to share in the revenues can be limited. For example, system 100 can limit the number of users that may share in the revenues and/or profit share to, for example, 5000 users. Of course, this number is merely exemplary and may be any other number. Once this limit is met, other users may still be able to sign up, buy and sell goods/services, and participate in all other functions of platform 103. However, only the initial users (e.g. first 5000 users) will receive any revenue and/or profit share. The user limit may be increased or decreased as desired or required. Additionally, in some embodiments, users who are not initial users can sign up for a waiting list that would allow them to participate in the sharing program when, for example, openings became available or the user limit was increased.

Separate categories may be used in system 100. For example, the user's share of the total net profit can be further divided into a plurality of categories based on the characteristics related to the product and/or service. Also, the user's share of the total net profit can be divided and distributed based on the type of user (e.g., individual, business, government, non-profit entity, etc.), the type of products/services (e.g., real estate, vehicles, electronics, books, etc.), the transaction amount (e.g., less than $1000, $1000-$10000, more than $10000) or the condition of the item (e.g., new, refurbished and used). Other category distinctions can also be used.

Users 104 can have funds (e.g., revenue shares) deposited directly into an account within or outside the system 100. Users 104 can also use these funds to purchase goods or services within the system 100 or outside the system 100. Savings, checking, investments and loans could also be originated from within system 100. System 100 can also be used as a buyer protection device where funds are held in an account and not released to the seller until the buyer receives the product or service.

System 100 can also be used as a clearinghouse to track the transactions and provide proof of the transactions. For example, the system can create a holding and/or merchant account where buyers can deposit payment for goods and/or services directly into an account by for example, credit card, check, cash, money order or any other suitable means. The funds can be deposited directly into the account using platform 103 or can be deposited using another system external to platform 103. System 100 can then hold the funds and allocate them to the seller of the item when all the transaction conditions have been met. The data obtained in the transaction can be used in future transactions within system 100.

In some embodiments, a credit card or membership card can be used in conjunction with system 100. The card could be used at sellers of goods and services inside or outside system 100. For example, a user could go to a retail store and use the card to purchase an item. The transaction amount for that item can then be added to the TGSP of all users of system 100 as well as the individual user's GSP. Revenues can also be generated from the use of the card. For example, retailers can pay a monthly fee to accept payment using the card or fees can be generated based on the gross sales of the card. These fees can also be added to the TGSP.

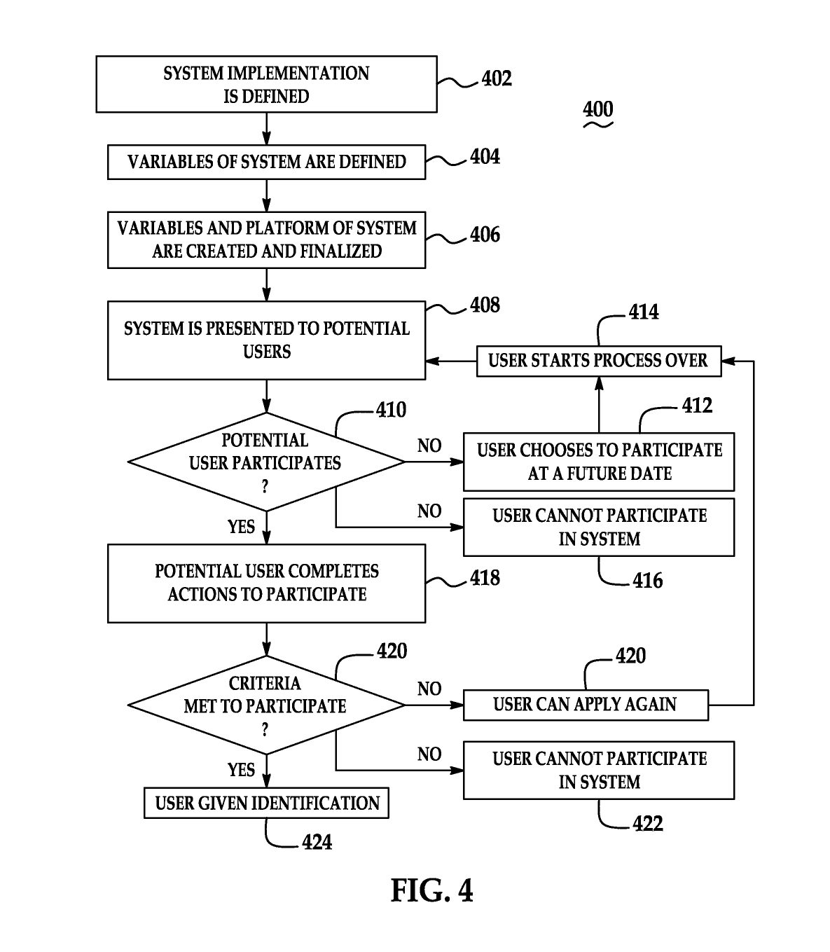

FIG. 4 illustrates a flow diagram 400 for creating system 100. At step 402 the platform is defined and/or created by, for example, platform operator 102. At step 404, variables, such as terms and conditions, of system 100 are defined. Additionally, incentive or compensation structures can also be defined and created at step 404. At step 406, variables and platforms of system 100 are created and finalized before being presented to potential users. At step 408, system 100 is presented to potential users by, for example, platform operator 102. In certain embodiments, system 100 is presented, for example, in a web-based implementation.

At step 410, potential user may, for example, review the terms, conditions, and variables presented and choose whether to participate or not. If the potential user does not choose to participate in system 100, the potential user can choose to participate at a future date at step 412. If the user chooses to participate at a future date, the potential user will start the process over at step 414 (e.g., step 402). Otherwise, at step 416, if the user does not, at present, choose to participate nor does the user choose to participate at a future date, the user may not be able to participate in system 100 at step 416.

At step 418, if the potential user chooses to participate in system 100, the potential user then completes all actions and meets all criteria as desired or required by system 100. The desired or required criteria and actions can be defined by the system terms, variables, and conditions. The terms and conditions can be in any form or type. One example of terms and conditions can be a signed or unsigned document or contract. Another example is the potential user completing required actions including agreement to the terms and conditions and entering into the contract or agreement.

At step 420, system 100 determines whether the criteria are met. If the criteria are not met, either the user can apply to participate in system 100 again at step 420 or the user cannot participate in system 100 at step 422. Once all the criteria are met, potential user can now be classified as an active or registered user (e.g., user 104). User 104 is then be approved to participate in the system 100 according to, for example, the agreed upon terms, conditions and variables.

Depending on the terms and conditions of system 100, user 104 may be given identification at step 424. Identification can be, for example, a member card, username and/or password. Other types of identification are also possible.

FIG. 5 illustrates a block diagram of an exemplary system 500 for sharing revenue according to another embodiment of the invention. The system 500 includes a business/platform owner or operator 502, a platform 503, users 504, a server 106 and affiliates 508. System 500 is similar to system 100 except that platform 503 is a non-web-based implementation. Accordingly, platform 503 is not connected to a communications network. Platform operator 502, users 504, server 506 and affiliates 508 are similar to platform operator 103, users 104, server 106 and affiliates 108 described in connection with system 100, so they are not described again.

Platform owner 502 controls, for example, the creation and operation of platform 503. Platform 503 is a non-web-based implementation such as a publication listing advertisements. Using system 500, platform operator 502 and users 504 share the profits that are generated within or by the use of platform 503. The amount of profit paid to users 504 can be scaled based on the net profit (or revenue) generated by platform 503. The TNP is based on, for example, buying and selling commission, advertisement revenues, affiliate revenues, retail sales of goods/services, retail purchases of goods/services and/or listing fees.

To calculate each user's profit share using platform 503, the same process can be used as described in connection with FIG. 3. The users 504 profit share can be calculated by server 506. Information regarding the sales and purchase can be, for example, input by platform operator 502.

For example, user 504 (i.e., seller) lists an advertisement that relays information regarding a good and/or service for sale, such as a car. Once user 504 (i.e., buyer) sees the advertisement, they can purchase the item listed in the advertisement. Similar to that of system 100, the transaction amount of the sale can be added to the TGSP.

Although the web-based implementation and the non-web-based implementation have been described separately for the sake of clarity, in some embodiments, the implementations may be combined into one system. For example, in one embodiment, a system can produce and distribute a paper publication in addition to providing a platform that permits the sale or advertisement of goods and/or services. Profits and/or revenues generated by both paper publication and the sale and goods and services can be shared between the users and the platform operator.

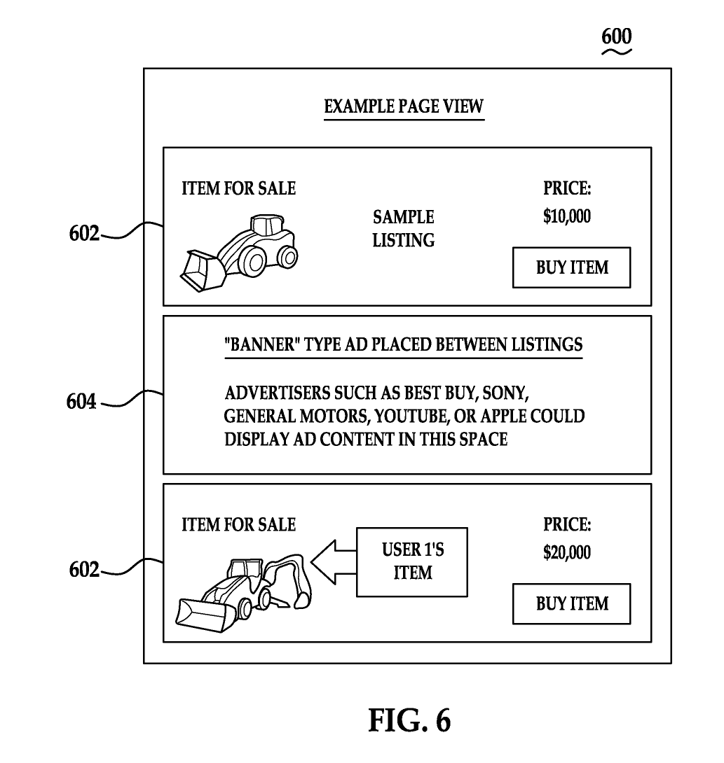

FIG. 6 is an exemplary user interface screen 600 of the system of FIG. 1 showing listings 602 of items for sale by users 104 and as well as a banner-type ad 604. The banner-type ad 604 is displayed between the listings. In this example, the user viewing the page is able to “click” on the “buy item” button or the “banner” ad. This example illustrates a direct sale format, but any sales format may be used such as an auction style format. In this example, the seller of the item is referred to as ‘User 1” and the buyer of the item is referred to as “User 2”. The person or entity that places a banner ad is referred to as “Advertiser”. A user can click on “banner” ad content.

To purchase an item, User 2 clicks on the “buy item” button. User 2 then performs any actions and steps to complete the transaction, Revenue shares are then calculated based upon the defined variables of the system. In this example, the transaction amount of $20,000 (the cost of the item) is added to User 2's total gross sales and purchases and to the seller's (that is, User 1's) total gross sales and purchases. User 2's revenue share % is then calculated based upon the two users within the system. The presented example only includes two users in the system and one transaction in a one month period to simplify the explanation. Of course, in other systems, there can be multiple users and multiple transactions. User revenue shares are calculated by the following in this example:

Buyer share: 20,000/40,000=0.5=50% of users revenue share; and

Seller Share: 20,000/40,000=0.5=50% of users revenue share.

In a further example, the total gross revenues from banner ads placed on the website for this one month period is $100,000. The platform operator 102 of the website receives, for example, 50% of this revenue totaling $50,000. Users 1 and 2 receive the remaining 50% of the revenues in this example, which would also be $50,000. User 1's share (i.e., the seller's share) in this example is 50% of $50,000, and User 2's share (i.e., the buyer's share) in this example is also 50% of $50,000.

With continued reference to FIG. 6, if a user such as User 2 clicks on the banner ad, a direct link to a particular product featured in the ad content that the participant may purchase is provided. Alternatively, the banner ad may link to the advertiser's site with a plurality of items for purchase. The banner ad could also be a non-clickable or clickable informational ad that could direct the user to call a phone number or visit a store location or any other means of directing or promoting a user towards a potential purchase. The advertisement could also be a clickable link to an informational site that does not offer goods or services for sale or a non-clickable ad with information directing a participant to information not related to the purchase of goods or services.

After the user uses the banner ad, the user may then make a decision to purchase a good or service promoted by or related to the ad content. If the user chooses to purchase a good or service through the ad content, the transaction amount of the purchase would be applied towards the user's total Gross Sales and Purchases amount and the TGSP amount of all users.

Depending on the system variables, the transaction amount may or may not be counted towards the total gross sales and purchases of the advertiser who placed the banner ad.

For example, if a seller of sells a $20,000 item (assuming no other sales), he will have a current GSP amount of $20,000. If the seller also purchases an item through a banner-type ad for $1,000, the seller will have a GSP of $21,000.

In some embodiments, if the goods or services that are purchased are then returned to the seller for a refund, the transaction amount can be deducted from the GSP of the purchaser. If a revenue share has already been paid out to the user, the amount of revenue paid out can also be deducted from any revenue shares due to the user. Alternatively, the user may be required to pay back the share if they have no revenue share due to them.

Listings 602 may be, for example, premier listings, basic listings or any other suitable type of listing. Premier listings typically provide more options, benefits and features than basic listings. For example, premier listings can include an automatic offer acceptance. In automatic offer acceptance, the buyer communicates an offer to the seller and in turn, the seller chooses to either accept or decline that offer. If the seller accepts the offer, the buyer can perform any steps necessary to complete the transaction.

To list an item using a premier listing, the seller may have to pay a listing fee. The listing fee can be, for example, a certain percentage of the item selling price and have minimum and maximum caps. Accordingly, for example, if the premier listing percentage fee is 2% with a $1 minimum and $100 maximum, a seller will pay no more than $100 to list an item. In this example, if the seller wishes to list an item for $200, the premier listing percentage fee would be $4. The seller may also choose to forgo listing the item using a premier listing and may list the item using a basic listing, which can have a significantly reduced or free listing price.

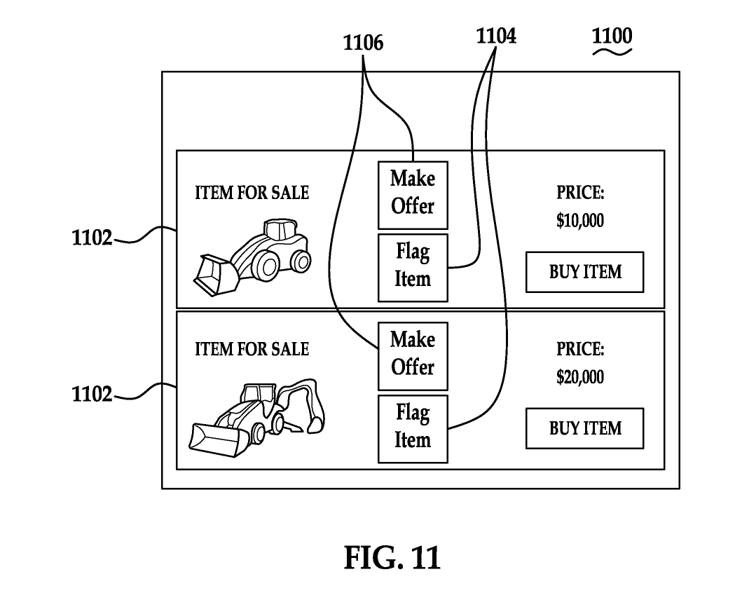

As illustrated in the exemplary user interface screen 1100 in FIG. 11, premier listings 1102 can also include an item flagging feature 1104. Item flagging feature 1104 permits a buyer to place an item on hold while simultaneously preventing other buyers from purchasing the item. As a result, a buyer who “flags” an item can, for example, have an opportunity to inspect the item before making the actual purchase. The item can also be marked as pending so no other buyers can, for example, view the seller's contact information or purchase the item because of its pending status. In other embodiments, marking the item using the flagging feature will prevent other buyers from viewing the listing. Although the item flagging feature is shown as a button, the flagging feature can be any other suitable structural element (e.g. checkbox, menu, etc.).

Premier listings can also include a make offer feature 1106. Make offer feature 1106 permits a buyer to submit a proposed price or an “offer” for the item. The offer is sent to the seller (e.g., by email) to decide whether they would like to accept the offer. The seller can have a predetermined amount of time (e.g. one week) for deciding whether to accept the offer. In some embodiments, the seller can have an indefinite amount of time for deciding whether to accept the offer. Although the make offer feature 1106 is shown as a button, the make offer feature can be any other suitable structural element (e.g. checkbox, menu, etc.).

If the seller accepts the buyer's offer, the buyer can be charged a fee for using the make offer feature 1106. For example, the buyer can pay a percentage of the offered price, a percentage of the original price, a flat fee or any other suitable charge. In some embodiments, the buyer can use the make offer feature 1106 free of charge. If the seller does not accept the buyer's offer, the buyer can be notified that the offer has been rejected (e.g., by email). The buyer can then resubmit another offer if desired. If the offer has been rejected, the buyer will not pay a fee for using the make offer feature 1106. However, in other embodiments, the buyer may have to pay a fee for using the make offer feature even though the offer was rejected. For example, the fee can be a percentage of the original price, a flat fee or any other suitable charge.

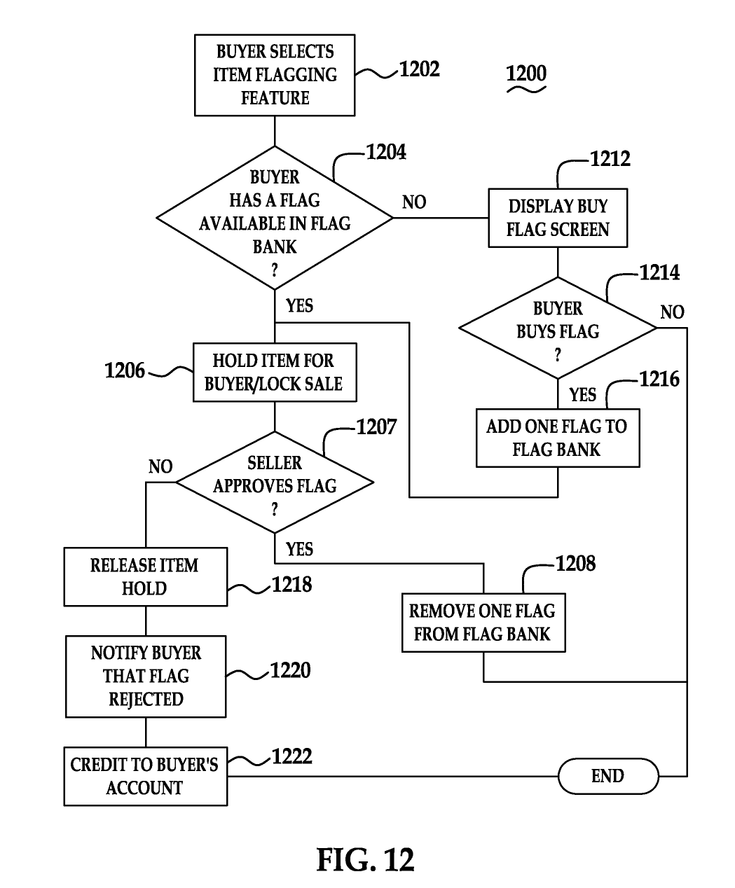

FIG. 12 is a flow diagram 1200 for flagging an item as used in system 100 of FIG. 1. At step 1202, system 100 will determine whether the buyer has selected the item flagging feature 1104 for a specific item, as discussed previously. Once system 100 detects that buyer has selected the item flagging feature, at step 1204, system 100 will determine whether the buyer has a flag available in a flag bank. The flag bank can store flags that have been previously or currently purchased by the user to use in connection with the item flagging feature. If the buyer has a flag available for use, at step 1206, system 100 will hold the specific item for the buyer (i.e. lock the sale). At step 1207, system 100 will notify the seller that the item has been flagged and will give the seller, for example, a predetermined amount of time to either accept or reject the flag. If the seller approves the flag, at step 1208, after the item has been held, one flag can be subtracted from the buyer's flag bank.

If the buyer does not have a flag available for use, at step 1212, system 100 can provide the buyer with an opportunity to purchase a flag by displaying a “buy flag” screen. At step 1214, system 100 can determine whether the buyer buys a flag. If the user chooses not to buy a flag, system 100 can return to the premier listing screen at step 1210. Otherwise, if the user chooses to buy a flag, system 100 can add one flag to the buyer's flag bank at step 1216. Then, system 100 can return to step 1206 to hold the specific item for the buyer. At step 1208, after the item has been held, one flag can be subtracted from the buyer's flag bank.

Returning to step 1207, if the seller does not approve the flag, because for example, the seller expressly rejects the flag or does not respond within the predetermined time, system 100 will release the hold of the item at step 1218, notify the buyer that the flag has been rejected at step 1220 and credit the flag and/or money used to buy the flag to the buyer's account at step 1222.

At times, buyers may miss out on opportunities to buy a certain good and/or service because for example, the buyer may not have time continuously check for new listings or there may be too many buyers competing to purchase the same product. In one embodiment, listings can be displayed according to a “first look” feature. If a listing is flagged as a first look listing, it can, for example, be shown to a smaller buyer audience (i.e. subscribers to first look listings) for a limited period of time (e.g. 24 hours). Members who subscribe to first look listings can, for example, increase their chance of buying a desired good and/or service by reducing the total number of buyers that have access to that listing. Users can, for example, sign up and pay for a first look membership that permits early access to the listings that have not been posted to all members. These first look listings will be, for example, unavailable to users who are not first look members/subscribers. FIG. 14 is a flow diagram 1400 for marking a listing as a first look listing. At step 1402, the seller posts a listing. The listing may be, as discussed previously, a premier listings, a basic listing or any other suitable type of listing. At step 1404, the new listing can be updated in a database of the system 100. Simultaneously or subsequently to posting the listing, the seller can indicate that the listing should be part of first look listings as described above. Accordingly, the seller can set a first look flag (e.g. by checking a checkbox) at step 1406. Of course, other suitable ways of setting the first look flag are also available. In other embodiments, the listing can be automatically included as a first look listing as soon as the seller posts the listing and it is updated in the system database. In other words, the seller will not have to indicate (as in step 1406) that the listing should be part of first look listings.

After the seller has indicated that the listing should be part of first look listings (or as described above, the listing is automatically included as part of first look listings), a listing timer can be set at step 1408. The listing timer can be for 24 hours, 48 hours or any other suitable length of time. In other embodiments, the time that a listing may be part of first look listings may dependent on another factor. For example, a seller may be in control for how long the listing is part of first look listings and may choose to keep or remove the first look feature as desired.

After a listing has been designated as a first look listing, system 100 displays the listing to members with first look membership at step 1410. In one embodiment, the first look listings are displayed to the user separately from other listings to the general public. In another embodiment, the first look listings are displayed with other listings. After the listing has been displayed, system 100 determines whether the listing timer has been expired at decision block 1412. If the timer has not expired, system 100 continually displays the listings to members with first look membership at step 1410. In some instances, system 100 may not continually display the first look listing if a condition has occurred. For example, if a buyer has purchased the item or if the item has been flagged using the make offer feature, the system 100 may remove the first look listing before the timer has expired. However, in other embodiments, the system 100 may keep displaying the listing notwithstanding these or other conditions. Returning to decision block 1412, if the timer has expired, the first look flag is cleared at step 1414. The listing is then displayed to all members regardless of first look membership at step 1416.

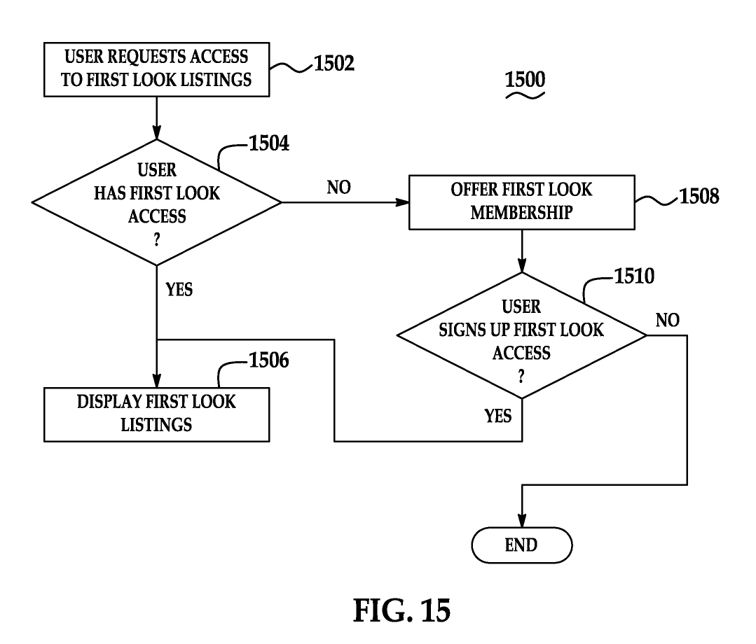

FIG. 15 is a flow diagram 1500 that can be performed by the system 100 for displaying first look listings. At step 1502, the user request access to first look listings. At decision block 1504, system 100 determiners whether the user has first look access. If the user has first look access, the first look listings are displayed at step 1506. If the user does not have access, the system 100 can offer the user a first look membership at step 1508. Further, at this step, system 100 may give the user a preview as to what items are available under first look listings. At decision block 1510, the system 100 can determine if the user signs up for first look access. If the user signs up for first look access, the system can return to step 1506 to display the first look listings to the user. If the user does not sign up for first look access, the routine can end (i.e. the user will not be able to view the first look listings).

The fee that can be charged for first look membership can be charged and/or paid on any schedule such as daily, weekly, monthly, yearly, or any other suitable timeframe. In other embodiments, there may be no fee for first look membership and access to the feature can be given based on, for example, participation, sales or any other suitable factor. The duration of the membership can also be on any schedule \as daily, weekly, monthly, yearly or any other suitable timeframe.

Further, revenue generated from listings that are designated as first look listing can be an additional source of revenue that can shared between the members as described herein. The revenue generated can be added to the revenue sharing pool or the prize pool as will be discussed hereafter. Of course, the revenue generated from first look listings may be used for any other suitable purpose.

In one embodiment, the first look feature can be split into tiers. For example, a higher membership fee can be paid by a member who is able to view listings before other first look members. For example, a member who pays a 30 dollar monthly membership fee on a first look listing with a 24 hour time limit may be able to view listings for the full 24 hours whereas a member who pays a 15 dollar monthly membership fee may be only able to view the listings during the last 12 hours of the 24 hours. Of course, these numbers are merely exemplary and any other suitable time limit or monetary amount may be used. Further, although two tiers are described, the embodiments described herein may utilize any number of tiers.

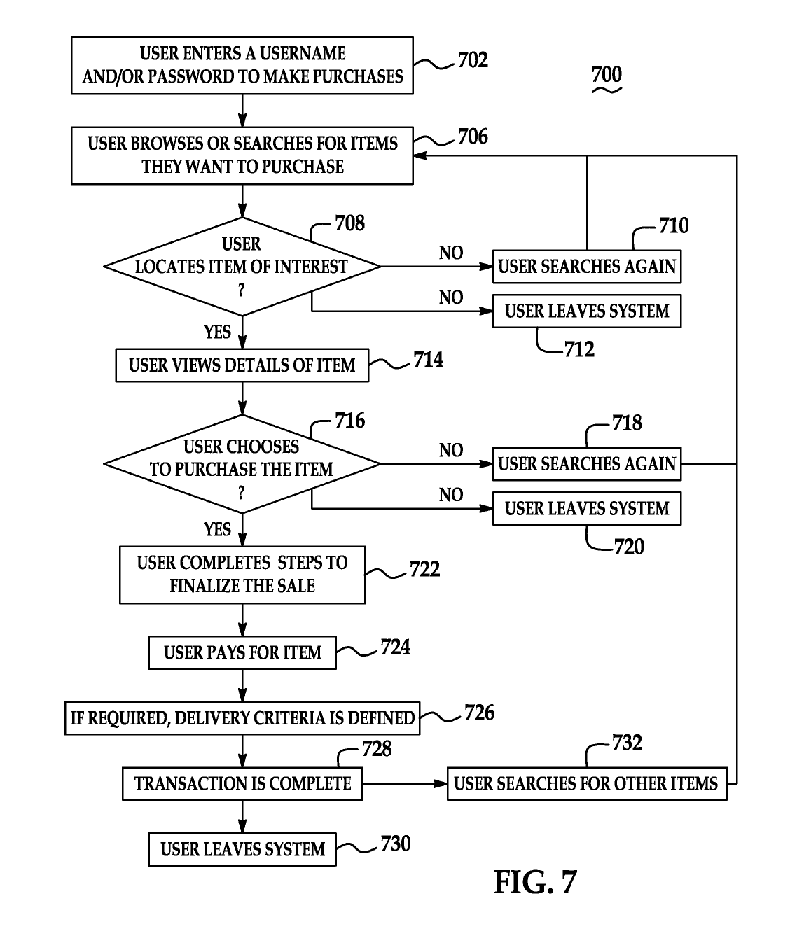

FIG. 7 shows a flow diagram 700 for permitting a user to purchase goods and/or services according to one example. Depending on system setup, the user may be required to enter a username and/or password to make purchases at step 702. Then, at step 706, the user browses or searches for items they want to purchase. If the user does not locate an item of interest at step 708, then the user searches again at step 710 and returns to step 706. Alternatively, the user can leave the system at step 712. If the user locates an item of interest at step 708, then the user can view the details of the item at step 714. If the user does not choose to purchase the item at step 716, then the user searches again at step 718 and returns to step 706. Alternatively, the user can leave the system at step 720. If the user chooses to purchase the item at step 716, the user can complete any steps to finalize the sale at step 722 and the user can pay for item at step 724. Then, if required, delivery criteria are defined at step 726. The transaction is completed at step 728. After the transaction is completed, the user can leave the system at 730. Alternatively, at step 732, the user can search for other items at step 718 and return to step 732.

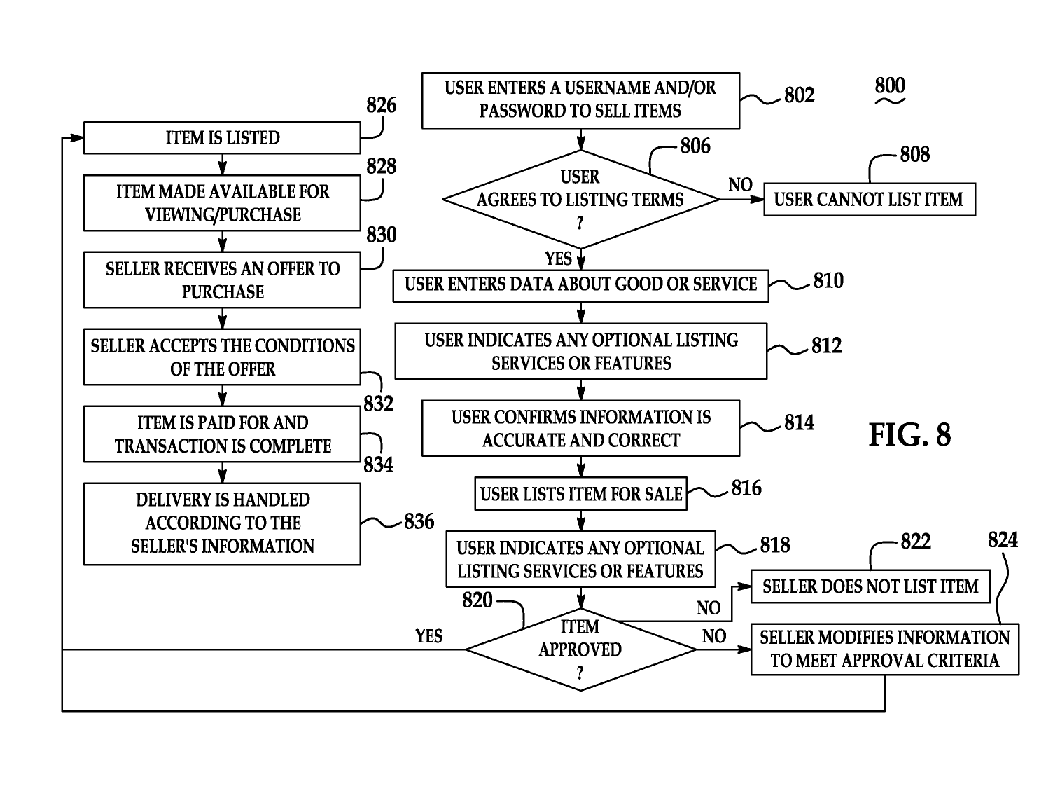

FIG. 8 shows a flow diagram 800 for permitting a user to sell goods and/or services according to one example. Depending on system setup, the user may be required to enter a username and/or password to sell items at step 802. Then, after the user is signed in, the user is presented with any listing terms at step 806. If the user does not agree to the listing terms, the user cannot list the item at step 808. If the user agrees to the listing terms at step 806, the user enters relevant data about good and/or service they are offering for sale such as a price, description, delivery and pictures at step 810. Then, the user can indicate any optional listing services or features by a defined action at step 812. The user confirms all information is accurate and coned at step 814.

The user lists item for sale by an action such as clicking on a link at step 816. Depending on terms, the item may have to be approved by the system before listing the item at step 818. If the item is to be approved at step 820, and the item is not approved, the seller does not list the item at step 822. However, if the item is approved or if the seller modifies information to meet approval criteria at step 824, the item is listed at step 826. At step 828, the item is now available for purchase and is able to be viewed so seller can accept offers or a purchase request. At step 830, the seller receives an offer to purchase. At step 832, the seller accepts the conditions of the offer. At step 834, the item is paid for and the transaction is complete. At step 836, if necessary, delivery is handled according to the seller's information

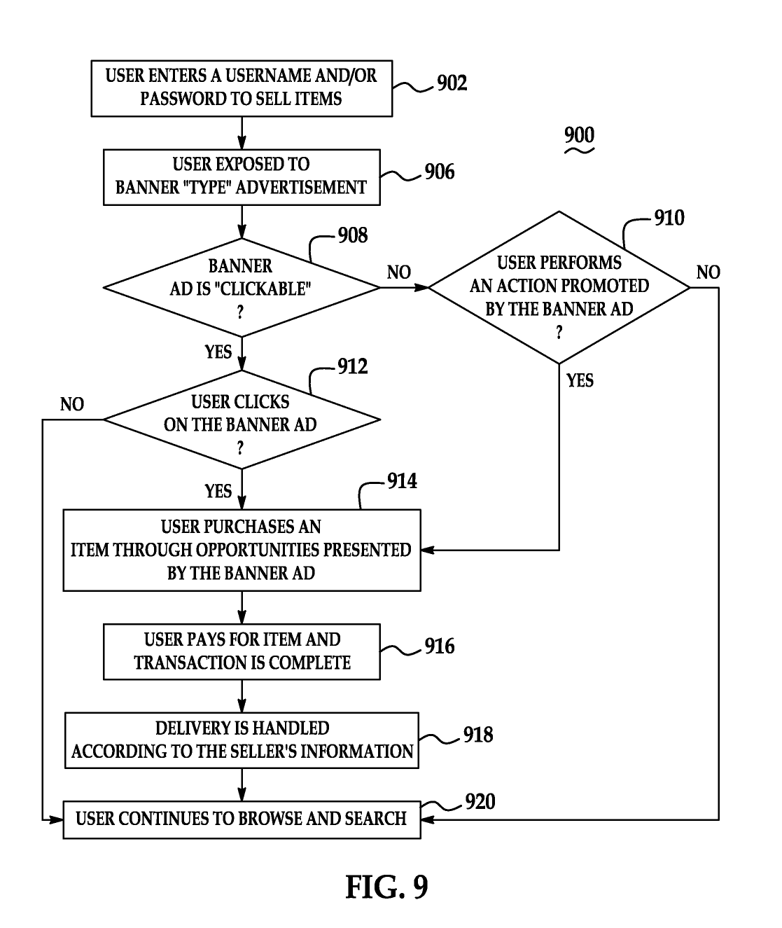

FIG. 9 shows a flow diagram 900 for permitting a user to purchase goods and/or services through a banner-type ad as described above in connection with FIG. 6. Depending on the system setup, the user may be required to enter a username and/or password to sell items at step 902. At step 906, the user is exposed to banner-type advertisement within the system while browsing or searching. If the system determines the banner-type ad is clickable at step 908, the user can choose whether they want to click on the banner ad at step 912. If the user does not choose to click on the banner ad, the user can continue to browse and search at step 920. If the user chooses to click on the banner ad, the user can choose to purchase an item through opportunities presented by the banner ad at step 914. Then, at step 916, the user pays for item and transaction is complete. If necessary, delivery is handled according to the seller's information at step 918. The user can then continue to browse and search at step 920.

Alternatively, if banner ad is not clickable at step 908, the user can perform an action promoted by the banner ad such as calling a phone number or visiting a linked website at step 910. If the user does not perform an action promoted by the banner ad, the user can continue to browse and search at step 920. However, if the user does perform an action promoted by the banner ad, the user can choose to purchase an item through opportunities presented by the banner ad at step 914. Then, at step 916, the user pays for item and transaction is complete. If necessary, delivery is handled according to the seller's information at step 918. The user can then continue to browse and search at step 920.

In some embodiments, an advertiser, website, publication or entity can place an audible or visual logo, symbol or any other identifying information on the platform or in places external to the platform (e.g. external website, retail store, etc.) The placement of the logo permits the advertiser, website, publication or entity to indicate that it participates in the system without directly placing an advertisement for a specific good/service or directly selling and buying goods/services within the system. Accordingly, any purchases made by a user could be counted toward that user's GSP amount. For example, a television ad could indicate that the company participates in the system by displaying a logo within the ad and playing an audio file when, for example, the user clicks on the logo. Additionally, for example, a website external to the platform that sells products can display a logo or other information letting visitors know that products that are bought by the user count toward a user's GSP amount.

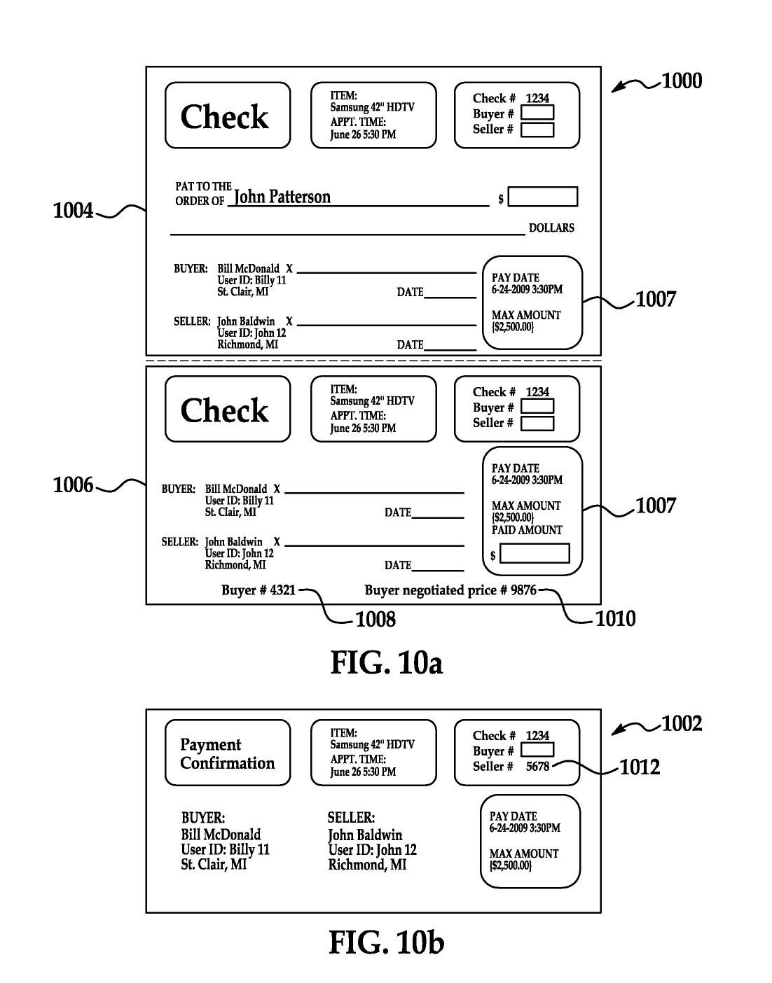

FIG. 10A illustrates a buyer's printout 1000 and FIG. 10B illustrates a seller's printout 1002 that can be used in system 100. These printouts can be used when a buyer wants to inspect and/or pick up an item that has been purchased before final payment. As such, once a buyer and seller agree on a price for an item, the buyer can make an initial payment for the item online (either partial or full payment) or a deposit for an item. Payment is made by credit or debit card, check, or any other means of transferring funds. If desired, the buyer can also set up an appointment online to meet the seller and inspect the item. Once payment is confirmed, it can be held in a third party holding account. Buyer receives buyer's printout 1000 by, for example, email, which includes a check for the seller 1004 (top half) and a receipt for the buyer 1006 (bottom half) providing proof of payment. Both check 1004 and receipt 1006 include a maximum amount 1007, which represents the payment that has been agreed to online. The buyer can print the printout 1000 and take it to the meeting with the seller. If the buyer has paid the full price for the item, the seller will receive a buyer# 1008 (i.e. the maximum amount 1007). If the buyer has not paid the full price for the item, the seller will receive a buyer negotiated price# 1010.

The seller also receives the seller's printout 1002 by, for example, email showing a confirmation of payment and a seller# 1012. The buyer and seller can then meet to exchange the item and pay the full price or negotiate a different payment as desired or required. If the sale is not completed, the buyer can receive the money he had initially transferred into the holding account. However, if a sale is made, the buyer and seller can verify each other's information by exchanging the information pertaining to buyer# 1008 and seller# 1012. Additionally, the final amount can be inserted on check 1004 and receipt 1006. Preferably, the final amount paid will not exceed maximum amount 1007.

Once the transaction is completed, the buyer can give check 1004 to seller. The buyer can keep receipt 1006 and can then take possession of the item. The seller can then log into their account and enter buyer# 1008 (or alternatively, buyer negotiated price# 1010), seller# and final amount paid. If the criteria entered by the seller are correct, the funds can be approved and transferred to the seller's account.

Accordingly, buyer's printout 1000 and seller's printout 1002 permit the buyer to inspect and/or pick up an item before final payment and at the same time, avoid the danger of purchasing an item in person from a stranger while carrying cash. Further, buyer's printout 1000 and seller's printout 1002 can also offer the convenience of circumventing the traditional procedures of paying using a bank and avoiding “no show” appointments.

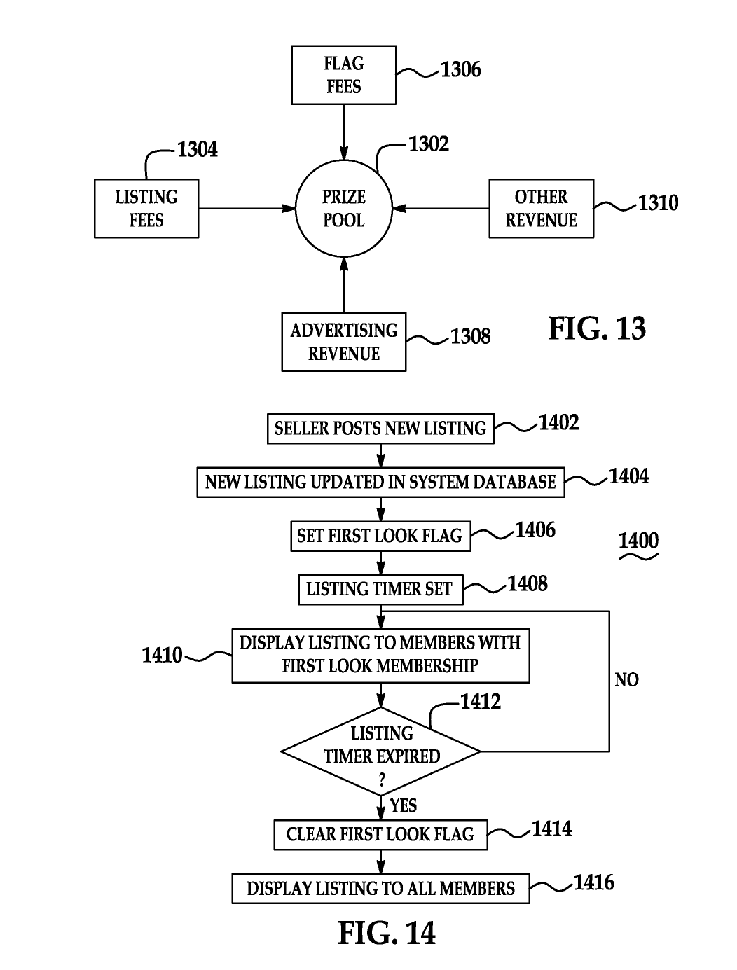

FIG. 13 illustrates another embodiment where revenue can be shared between the users of the system and the platform operator based on revenue contributions to a prize pool 1302. Revenue contributions to prize pool 1302 can include all or a portion of all listing fees 1304 (e.g., percentage of premier listing fees discussed previously), flag fees 1306, advertising revenue and other revenues 1310 generated by the site or external to the site. Advertising revenue can also include a portion of purchases made on their advertiser's website. Revenue can then be distributed to users during a drawing. Similar to the embodiment shown in FIG. 1, this embodiment can be implemented using the same or similar architecture. For example, a server (such as server 106), which is either separate from or integrated with the platform, can provide one or more prize pools, contribute revenue to the prize pool based on the revenue contributions, provide drawing entries to the plurality of users and select the drawing entries.

The drawing can take place, for example, every day, month, year etc or any other time period. Any number of users can be involved in the drawing. In other embodiments, the time period does not have to be fixed and may be at random. The prize pool can contain, for example, tangible or intangible goods and/or services, free premier listings, and any other form of compensation or reward. services, free premier listings, and any other form of compensation or reward. Any number of prizes can be given in one drawing. For example, there may be a number of prize categories such as 1st prize, 2nd prize, 3rd prize, etc. with one winner or a plurality of winners in each category. Prizes can be paid to all users or any portion of users.

The users can obtain drawing entries, by for example, purchasing a flag, obtaining a certain number of drawing entries for every dollar they spend in listing fees, posting a predetermined number of premier listings, posting a predetermined number of basic listings, a gross sales and purchases amount of the user, referrals to friends and family members, receiving positive feedback following a transaction or any other suitable factor. Drawing entries can also be provided for free, for example, through requesting the entry by mail. In other embodiments, there may be more than one prize pool. For example, a first prize pool can be reserved for a current monthly drawing where the prize amounts and number of drawings may not change. A second prize pool can be reserved for a progressive prize pool where prize amounts and number of drawings can change progressively until the end of month.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method of sharing revenue contributions between a plurality of users, comprising:
providing at least one prize pool;
contributing revenue to the at least one prize pool based on at least one revenue source;
providing drawing entries to the plurality of users;
selecting at least one of a plurality of drawing entries; and
awarding a prize to at least one of the plurality of users from the at least one prize pool.

2. The method of claim 1, wherein the revenue source is at least one of selling fees, listing fees, first look fees and advertising revenue.

3. The method of claim 1, wherein providing drawing entries further comprises at least one of:
providing a drawing entry for purchasing a flag;
providing a drawing entry per a predetermined amount in listing fees;
providing a drawing entry for posting a predetermined number of premier listings;
providing a drawing entry for posting a predetermined number of basic listings;
providing a drawing entry based on a gross sales and purchases (GSP) amount for the user;
providing a drawing entry for a referral; and
providing a drawing entry for positive feedback following a transaction.

4. The method of claim 1, wherein at least one of the drawing entries are provided free.

5. The method of claim 1, wherein the at least one prize pool includes a first prize pool and a second prize pool, the first prize pool includes at least one of a plurality of prizes and a plurality of drawings that do not change before selection of the next drawing entry.

6. The method of claim 5, wherein the second prize pool includes at least one of a plurality of prizes and a plurality of drawings that change before selection of the next drawing entry.

7. The method of claim 1, wherein the at least one of a plurality of drawing entries is selected one of daily, weekly, monthly and yearly.

8. A system for sharing revenue contributions between a plurality of users, comprising:
a plurality of user computers configured to permit the plurality of users to initiate a transaction over a communications network;
a platform controlled by the platform operator and configured to communicate with the plurality of user computers over the communications network and to process the transaction; and
a server in communication with the platform, the server configured to:
provide at least one prize pool;
contribute revenue to the at least one prize pool based on at least one revenue source;
provide drawing entries to the plurality of users; and
selecting at least one of a plurality of drawing entries.

9. The system of claim 8, wherein the revenue source is at least one of selling fees, listing fees, first look fees and advertising revenue.

10. The system of claim 8, wherein the server is further configured to provide the drawing entries comprises at least one of:
provide a drawing entry for purchasing a flag;
provide a drawing entry per a predetermined amount in listing fees;
provide a drawing entry for posting a predetermined number of premier listings;
provide a drawing entry for posting a predetermined number of basic listings;
provide a drawing entry based on a gross sales and purchases (GSP) amount for the user;
provide a drawing entry for a referral; and
provide a drawing entry for positive feedback following a transaction.

11. The system of claim 8, wherein at least one of the drawing entries are provided free.

12. The system of claim 8, wherein the at least one prize pool includes a first prize pool and a second prize pool, the first prize pool includes at least one of a plurality of prizes and a plurality of drawings that do not change before selection of the next drawing entry.

13. The system of claim 12, wherein the second prize pool includes at least one of a plurality of prizes and a plurality of drawings that change before selection of the next drawing entry.

14. The system of claim 8, wherein the at least one of a plurality of drawing entries is selected one of daily, weekly, monthly and yearly.

15. The system of claim 8, wherein a prize is awarded to the at least one of the plurality of users from the at least one prize pool.

16. The system of claim 8, wherein the server and the platform are integrated.

17. A method of sharing revenue between a plurality of users and a platform operator, comprising:
calculating a gross sales and purchases (GSP) amount for each of the plurality of users;
calculating a total gross sales and purchases amount (TGSP) based on the sum of the GSP amounts;
calculating a net profit share for a user based on a user's GSP amount relative to the TGSP;
calculating a total net profit (TNP) based on a revenue source;
calculating a total share of the TNP for the plurality of users; and
distributing revenue to the user based on the net profit share of the user and the total share of the TNP for the plurality of users.

18. The method of claim 17, wherein the revenue source is at least one of a buying commission, a selling commission, advertisement revenue, affiliate revenue, a retail sale of goods, a retail sale of services, a retail purchase of goods, a retail purchase of services and a listing fee.

19. The method of claim 17, wherein the total net revenue includes at least a portion of the total net profit.

20. The method of claim 17, further comprising:
distributing revenue to the platform operator based on the net profit share of the user and the total share of the TNP for the plurality of users.
